(19) United States
(12) Patent Application Publication
(10) Pub. No.: US 2022/0216511 A1
(43) Pub. Date: Jul. 7, 2022

(54) POLYMER, ELECTROLYTE, AND LITHIUM-ION BATTERY EMPLOYING THE SAME

(71) Applicant: INDUSTRIAL TECHNOLOGY RESEARCH INSTITUTE, Hsinchu (TW)

(72) Inventors: Jen-Chih LO, Hsinchu City (TW); Ting-Ju YEH, Taipei City (TW); Ya-Chi CHANG, Zhunan Township (TW); Chen-Chung CHEN, Taoyuan City (TW); Chi-Ju CHENG, Zhudong Township (TW); Jin-Ming CHEN, Taoyuan City (TW)

(73) Assignee: INDUSTRIAL TECHNOLOGY RESEARCH INSTITUTE, Hsinchu (TW)

(21) Appl. No.: 17/559,191

(22) Filed: Dec. 22, 2021

Related U.S. Application Data
(60) Provisional application No. 63/131,141, filed on Dec. 28, 2020.

(51) Int. Cl. H01M 10/0565; H01M 10/0525

(52) U.S. Cl. CPC H01M 10/0565; H01M 2300/0082; H01M 10/0525

(57) ABSTRACT

A polymer, an electrolyte, and a lithium-ion battery employing the same are provided. The polymer is a product of a composition via a polymerization. The composition includes a first monomer and a second monomer. The first monomer has a structure represented by Formula (I)

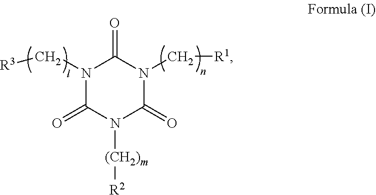

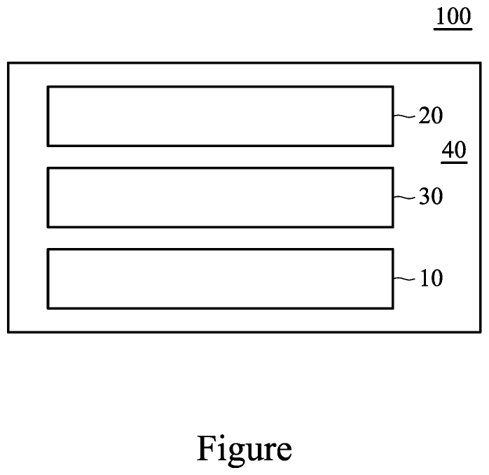

and the second monomer is fluorine-containing acrylate, fluorine-containing alkene, fluorine-containing epoxide, or a combination thereof. Particularly, n, m, and l are independently 1, 2, 3, 4, 5, or 6; and, R¹, R², R³, R⁴, R⁵ and R⁶ are as defined in the specification.

### CROSS REFERENCE TO RELATED APPLICATIONS

This application claims the benefit of U. S. Provisional Application No. 63/131,141, filed on Dec. 28, 2020, which is hereby incorporated herein by reference.

### TECHNICAL FIELD

The disclosure relates to a polymer, an electrolyte, and a lithium-ion battery employing the same.

### BACKGROUND

Lithium-ion secondary batteries are mainstream commercial products, and they are presently being developed to be light-weight, low-volume, and safer, and to have a higher energy capacity and a longer life cycle. In conventional liquid electrolyte lithium-ion batteries, the energy storage cost per unit is high due to the low gravimetric energy density and the limited life cycle. However, unilaterally increasing the energy density of batteries can easily induce serial safety problems in electrochemical batteries, such as liquid leakage, battery swelling, heating, fuming, burning, explosion, and the like.

In addition, when improving the operating voltage of lithium ion battery, it is easy to accelerate the oxidation reaction of electrolyte, resulting in poor stability of polymer as electrolyte additive to improve stability, the conventional polymer used in the electrolyte has a high interfacial impedance in the electrolyte system, and cannot effectively inhibit the oxidation reaction of the electrolyte.

Therefore, a novel design of an electrolyte used in the lithium-ion battery is called for to solve the aforementioned problems.

### SUMMARY

According to embodiments of the disclosure, the disclosure provides a polymer. The polymer can be a product of a composition via a reaction (such as polymerization). According to embodiments of the disclosure, the composition can include a first monomer and a second monomer. The first monomer can have a structure represented by Formula (I), The second monomer can be a fluorine-containing acrylate, fluorine-containing alkene, fluorine-containing epoxide, or a combination thereof

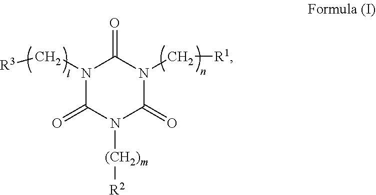

wherein n, m, and l can be independently 1, 2, 3, 4, 5, or 6, R¹, R², and R³ can be independently —OH,

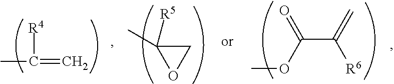

R⁴, R⁵, and R⁶ can be independently hydrogen or C₁₋₃ alkyl group.

According to other embodiments of the disclosure, the disclosure provides an electrolyte, such as an electrolyte used in lithium-ion battery. The electrolyte can include a lithium salt, a solvent, and the aforementioned polymer (serving as an electrolyte additive). According to embodiments of the disclosure, the amount of polymer can be 2 wt % to 20 wt %, based on the total weight of the solvent, lithium salt and polymer.

According to other embodiments of the disclosure, the disclosure provides a lithium-ion battery, such as lithium ion secondary battery. The lithium-ion battery can include a positive electrode, a negative electrode, a separator, and aforementioned electrolyte. In particular, the separator is disposed between the positive electrode and the negative electrode; and, the electrolyte can be disposed between the positive electrode and negative electrode.

A detailed description is given in the following embodiments.

### BRIEF DESCRIPTION OF THE DRAWINGS

FIGURE is a schematic view of a lithium-ion battery according to embodiments of the disclosure.

### DETAILED DESCRIPTION

The polymer, electrolyte, and lithium-ion battery of the disclosure are described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. As used herein, the term “about” in quantitative terms refers to plus or minus an amount that is general and reasonable to persons skilled in the art.

It should be noted that the elements or devices in the drawings of the disclosure may be present in any form or morphology known to those skilled in the art. In addition, the expression “a layer overlying another layer”, “a layer is disposed above another layer”, “a layer is disposed on another layer” and “a layer is disposed over another layer” may refer to a layer that directly contacts the other layer, and they may also refer to a layer that does not directly contact the other layer, there being one or more intermediate layers disposed between the layer and the other laver.

The drawings described are only schematic and are non-limiting, in the drawings, the size, shape, or thickness of some of the elements may be exaggerated and not drawn on scale for illustrative purposes. The dimensions and the relative dimensions do not correspond to actual location to practice of the disclosure. The disclosure will be described with respect to particular embodiments and with reference to certain drawings but the disclosure is not limited thereto.

The disclosure provides a polymer. The polymer of the disclosure can have a looser three-dimensional network structure and exhibit a better thermal stability, since the isocyanurate monomer with three reactive functional groups (i.e. the first monomer) is reacted with the fluorine-containing reactive monomer within a specific ratio. Further, the polymer of the disclosure is a fluorine-containing polymer. Due to the hydrophobicity of the fluorine-containing polymer, the amount of moisture passing through it can be reduced, thereby avoiding loss of performance of the battery. The disclosure also provides an electrolyte (such as the electrolyte used in lithium-ion batteries). The electrolyte can be a quasi-solid electrolyte, which can be prepared by adding a composition including the first monomer and the second monomer into a solution having a lithium salt and thus subjecting the result to a heating process. Due to the looser three-dimensional network structure of the polymer, the polymer in the electrolyte of the disclosure can adsorb lithium salt and solvent via the intermolecular force, thereby reducing the interfacial impedance of the electrolyte and enhancing the ionic conductivity of the electrolyte (approximating the ionic conductivity (such as about 1×10⁻² S/cm−9×10⁻³ S/cm) of a liquid electrolyte). As a result, the electrochemical window of the electrolyte is increased. In addition, since the polymer is derived from a fluorine-containing reactive monomer, the flame retardance of the whole electrolyte can be enhanced, and the electrolyte can exhibit an ability to inhibit oxidation at high voltage simultaneously. In the electrolyte, the polymer is used in concert with the lithium salt and solvent within a specific ratio, in order to ensure that the electrolyte meets the requirement of the high voltage lithium-ion battery. According to embodiments n of the disclosure, the disclosure also provides a lithium-ion battery. The lithium-ion battery includes the aforementioned electrolyte. By means of the electrolyte of the disclosure, the lithium-ion battery can exhibit improved C-rate discharge ability and increased life cycle.

According to embodiments of the disclosure, the disclosure provides a polymer. The polymer can be a product of a composition via a polymerization. According to embodiments of the disclosure, the composition can include a first monomer and a second monomer. The first monomer can have a structure represented by Formula (I). The second monomer can be fluorine-containing acrylate, fluorine-containing alkene, fluorine-containing epoxide, or a combination thereof.

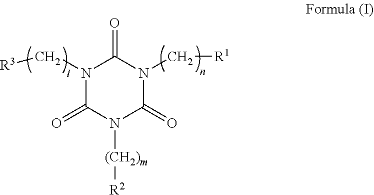

In particular, n, m, and l can be independently 1, 2, 3, 4, 5, or 6; R¹, R², and R³ can be independently —OH.

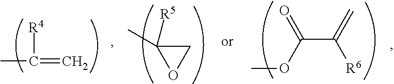

R⁴, R⁵, and R⁶ can be independently hydrogen or C₁₋₃ alkyl group. According to embodiments of the disclosure, the C₁₋₃ alkyl group of the disclosure can be a linear or branched alkyl group. For example, C₁₋₃ alkyl group can be methyl group, ethyl group, propyl group; or an isomer thereof.

According to embodiments of the disclosure, the first monomer can perform a self-polymerization or a copolymerization with the second monomer, thereby forcing the polymer ha ng a three-dimensional network structure. According to embodiments of the disclosure, the weight ratio of the first monomer to the second monomer can be about 5:1 to 1:2, such as 4:1, 3:1, 2:1; 1:1, or 2:3, When the weight ratio of the first monomer to the second monomer is too high, the obtained polymer has a denser three-dimensional network structure, resulting in that the fluorine amount of polymer is reduced. As a result, the interfacial impedance of the electrolyte including the polymer is increased the ionic conductivity of the electrolyte is reduced, and the obtained electrolyte is apt to undergo an oxidation when operating at high voltage. In addition, when the weight ratio of the first monomer to the second monomer is too low; the polymer cannot be solidified to form an electrolyte, resulting in that the electrolyte is apt to undergo an oxidation when operating at high voltage, the irreversible capacity loss is increased and the life cycle of the battery is deteriorated.

According to embodiments of the disclosure, the first monomer can be

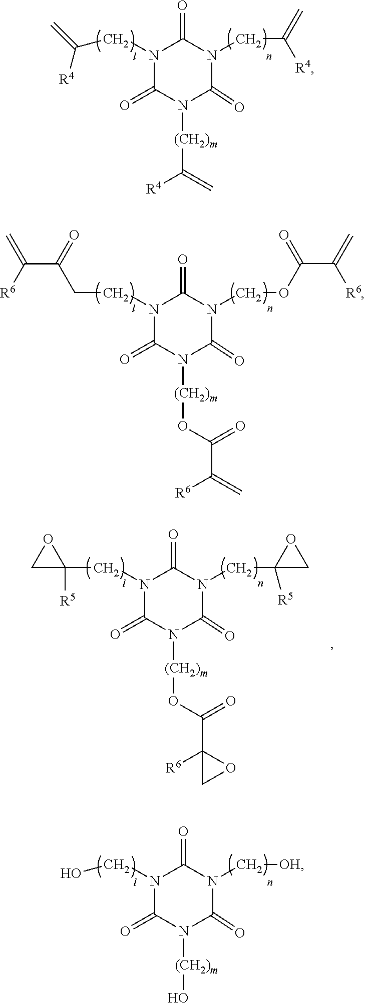

or a combination thereof. In particular, R⁴, R⁵, and R⁶ are independently hydrogen or C₁₋₃ alkyl group.

According to embodiments of the disclosure, the first monomer can be 1,3,5-triallyl isocyanurate (TAIC), 1,3,5-trimethallyl isocyanurate (TMAIC), 1,3,5-tris(2-hydroxyethyl)isocyanurate, triglycidyl isocyanurate, tris[2-(acryloyloxy)ethyl]isocyanurate, or a combination thereof.

According to embodiments of the disclosure, the second monomer can be a fluorine-containing acrylate. According to embodiments of the disclosure, the second monomer can be a fluorine-containing compound having an acrylate group. The second monomer can be fluorine-containing compound having one acrylate group or fluorine-containing compound having two acrylate groups. According to embodiments of the disclosure, the fluorine-containing acrylate can have a structure represented by Formula (II)

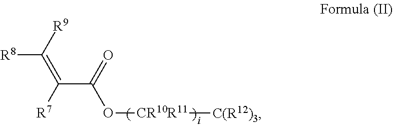

wherein i is 0, 1, 2, 3, 4, 5, 6, 7, 8, or 9; R⁷, R⁸, R⁹, R¹⁰, R¹¹, and R¹² are independently hydrogen, fluorine, C₁₋₃ alkyl group, or C₁₋₃ fluoroalkyl group, and at least one of R⁷, R⁸, R⁹, R¹⁰, R¹¹ and R¹² can be fluorine or C₁₋₃ fluoroalkyl group. According to embodiments of the disclosure, when i is 2, 3, 4, 5, 6, 7, 8, or 9, RIG are independently hydrogen, fluorine, C₁₋₃ alkyl group, or C₁₋₃ fluoroalkyl group, and R¹¹ are independently hydrogen, fluorine, C₁₋₃ alkyl group, or C₁₋₃ fluoroalkyl group. According to embodiments of the disclosure, the fluorine-containing acrylate can have a structure represented by Formula (III)

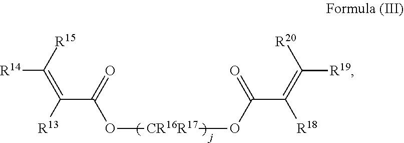

wherein j is 1, 2, 3, 4, 5, or 6; R¹³, R¹⁴, R¹⁵, R¹⁶, R¹⁷, R¹⁸, R¹⁹, and R²⁰ are independently hydrogen, fluorine, C₁₋₃ alkyl group, or C₁₋₃ fluoroalkyl group, and at least one of R¹³, R¹⁴, R¹⁵R¹⁶, R¹⁷, R¹⁸, R¹⁹, and R²⁰ can be fluorine or C₁₋₃ fluoroalkyl group. According to embodiments of the disclosure, when j is 2, 3, 4, 5, or 6, R¹⁶ are independently hydrogen, fluorine, C₁₋₃ alkyl group, or C₁₋₃ fluoroalkyl group, and R¹⁷ are independently hydrogen, fluorine, C₁₋₃ alkyl group, or C₁₋₃ fluoroalkyl group. The C₁₋₃ fluoroalkyl group of the disclosure can be an alkyl group which a part of or all hydrogen atoms bonded on the carbon atom are replaced with fluoride atoms, and C₁₋₃ fluoroalkyl group can be linear or branched fluoroalkyl group. According to embodiments of the disclosure, C₁₋₃ fluoroalkyl group can be fluoromethyl, fluoroethyl, fluoropropyl, or an isomer thereof. Herein, fluoromethyl group can be monofluoromethyl group, difluoromethyl group, or trifluoromethyl group; and, fluoroethyl group can be monofluoroethyl group, difluoroethyl group, trifluoroethyl group, tetrafluoroethyl group, or pentafluoroethyl.

According to embodiments of the disclosure, the fluorine-containing acrylate can be methyl 2-fluoroacrylate, ethyl 2-fluoroacrylate, ethyl 4,4,4-trifluorocrotonate, 1,6-bis(acryloyloxy)-2,2,3,3,4,4,5,5-octafluorohexane, 1H,1H,2H,2H-heptadecafluorodecyl acrylate,1H,1H,2H,2H-nonafluorohexyl acrylate,1,1,1,3,3,3-hexafluoroisopropyl acrylate,1H,1H,2H,2H-heptadecafluorodecyl acrylate,1H,1H,2H,2H-heptadecafluorodecyl methacrylate, 1H,1H,3H-hexafluorobutyl acrylate,1H,1H,3H-hexafluorobutyl methacrylate, 1H,1H,3H-tetrafluoropropyl methacrylate,1H,1H,5H-octafluoropentyl acrylate, 1H,1H,5H-octafluoropentyl methacrylate,1H,1H,7H-dodecafluoroheptyl methacrylate,1H,1H-heptafluorobutyl acrylate, 2,2,2-trifluoroethyl acrylate, 2,2,2-trifluoroethyl methacrylate, hexafluoro-iso-propyl methacrylate, or a combination thereof.

According to embodiments of the disclosure, the second monomer can be fluorine-containing alkene. According to embodiments of the disclosure, the second monomer can be fluorine-containing compound having a vinyl group. According to embodiments of the disclosure, the fluorine-containing alkene can have a structure represented by Formula (IV)

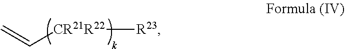

wherein k is 1, 2, 3, 4, 5, 6, 7, 8, or 9; and, R²¹, R²², and R²³ are independently hydrogen or fluorine. According to embodiments of the disclosure, at least one of R²¹, R²², and R²³ is fluorine.

According to embodiments of the disclosure, the fluorine-containing alkene can be perfluoropropyl ethylene, perfluorobutyl ethylene, perfluoropentyl ethylene, perfluorohexyl ethylene, perfluoroheptyl ethylene, perfluorooctyl ethylene, or a combination thereof.

According to embodiments of the disclosure, the second monomer can be fluorine-containing epoxide. According to embodiments of the disclosure, the second monomer can be a fluorine-containing compound having an epoxy group. The fluorine-containing epoxide can have a structure represented by Formula (V)

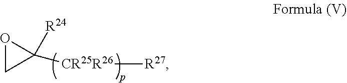

wherein p is 1, 2, 3, 4, 5, 6, 7, 8, or 9; R²⁴ is hydrogen, fluorine or C₁₋₃ alkyl group; and, R²⁵, R²⁶, and R²⁷ are independently hydrogen, or fluorine. According to embodiments of the disclosure, at least one of R²⁴ and R²⁷ is fluorine. According to embodiments of the disclosure, the fluorine-containing epoxide is 3-perfluorooctyl-1,2-epoxypropane.

According to embodiments of the disclosure, the second monomer can be methyl 2-fluoroacrylate, ethyl 2-fluoroacrylate, ethyl 4,4,4-trifluorocrotonate, 1,6-bis(acrylloxy)-2,2,3,3,4,4,5,5-octafluorohexane, 1H,1H,2H,2H-heptadecafluorodecyl acrylate,1H,1H,2H,2H-nonafluorohexyl acrylate,1,1,1,3,3,3-hexafluoroisopropyl acrylate,1H,1H,2H,2H-heptadecafluorodecyl acrylate, 1H,1H,2H,2H-heptadecafluorodecy methacrylate,1H,1H,3H-hexafluorobutyl acrylate,1H,1H,3H-hexalfluorobutyl methacrylate,1H,1H,3H-tetrafluoropropyl methacrylate,1H,1H,5H-octafluoropentyl acrylate,1H,1H,5H-octafluoropentyl methacrylate,1H,1H,7H-dodecafluoroheptyl methacrylate,1H,1H-heptafluorobutyl acrylate, 2,2,2-trifluoroethyl acrylate, 2,2,2-trifluoroethyl methacrylate, hexafluoro-iso-propyl methacrylate, perfluoropropyl ethylene, perfluorobutyl ethylene, perfluoropentyl ethylene, perfluorohexyl ethylene, perfluoroheptyl ethylene, perfluorooctyl ethylene, 3-perfluorooctyl-1,2-epoxypropane, or a combination thereof.

According to embodiments of the disclosure, when the first monomer is

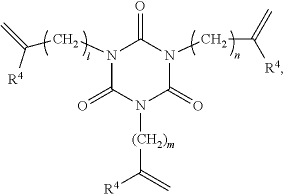

the second monomer is fluorine-containing acrylate or fluorine-containing alkene.

According to embodiments of the disclosure, when the first monomer is

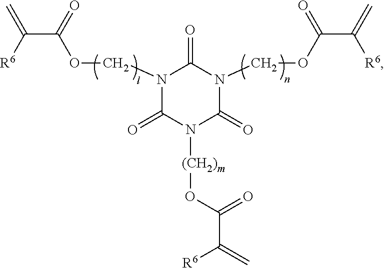

the second monomer is fluorine-containing acrylate or fluorine-containing alkene.

According to embodiments of the disclosure, wherein the first monomer

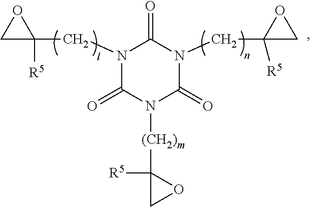

is the second monomer is fluorine-containing epoxide.

According to embodiments of the disclosure, when the first monomer is

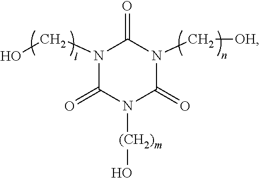

the second monomer is fluorine-containing epoxide.

According to embodiments of the disclosure, the composition for preparing the polymer can further include an initiator. According to embodiments of the disclosure, the amount of initiator can be about 001 wt % to 10 wt % (such as 0.1 wt %, 0.5 wt %, 1 wt %, 2 wt %, 3 wt %, 4 wt %, 5 wt %, 6 wt %, 7 wt %, 8 wt %, or 9 wt %) based on the total weight of the first monomer and second monomer. According to embodiments of the disclosure, the initiator can be photo-initiator, thermal initiator, electron-beam initiator, or a combination thereof.

According to embodiments of the disclosure, the initiator can be a, benzoin-based compound, acetophenone-based compound, thioxanthone-based n compound, ketal compound, benzophenone-based compound, α-aminoacetophenone compound, acyl phosphine oxide compound, biimidazole-based compound, triazine-based compound, or a combination thereof. The benzoin-based compound can be benzoin, benzoin methyl ether, or benzyl dimethyl ketal; acetophenone-based compound, can be p-dimethylamino-acetophenone, α,α′-dimethoxyazoxy-acetophenone, 2,2′-dimethyl-2-phenyl-acetophenone, oxy-acetophenone, 2-methyl-1-(4-methylthiophenyl)-2-morpholino-1-proparione or 2-benzyl-2-N,N-dimethylamino-1-(4-morpholinophenyl)-1-butanone; the benzophenone-based compound can be benzophenone, 4,4-bis(dimethylamino)benzophenone, 4,4-bis(diethylamino)benzophenone, 2,4,6-trimethylaminobenzophenone, methyl-o-benzoyl benzoate, 3,3-dimethyl-4-methoxybenzophenone, or 3,3,4,4-tetra(t-butylperoxycarbonyl)benzophenone the thioxanthone-based compound can be thioxanthone, 2,4-diethyl-thioxanthanone, or thioxanthone-4-sulfone; the biimidazole-based compound can be 2,2′-bis(o-chlorophenyl)-4,4′,5,5′-tetraphenyl-biimidazole, 2,2′-bis(o-fluorophenyl)-4,4′,5,5′-tetraphenyl-biimidazole, 2,2′-bis(o-methylphenyl)-4,4′,5,5′-tetraphenyl-biimidazole, 2,2′-bis(o-methoxyphenyl)-4,4′,5,5′-tetraphenyl-biimidazole, 2,2′-bis(o-ethylphenyl)-4,4′,5,5′-tetraphenyl-biimidazole, 2,2′-bis(p-methoxyphenyl)-4,4′,5,5′-tetraphenyl-biimidazole, 2,2′-bis(2,2′,4,4′-tetramethoxyphenyl)-4,4′,5,5′-tetraphenyl-biimidazole, 2,2′-bis(2-chlorophenyl)-4,4′,5,5′-tetraphenyl-biimidazole, or 2,2′-bis(2,4-dichlorophenyl)-4,4′,5,5′-tetraphenyl-biimidazole: the acylphosphine oxide compound can be 2,4,6-trimethylbenzoyl diphenylphosphine oxide or bis(2,6-dimethoxybenzoyl)-2,4,4-trimethylpentylphosphine oxide: the triazine-based compound can be 3-{4-[2,4-bis(trichloromethyl)-s-triazine-6-yl]phenylthio}propionic acid, 1,1,1,3,3,3-hexafluoroisopropyl-3-{4-[2,4-bis(trichloromethyl)-s-triazine-6-yl]phenylthio}propionate, ethyl-2-{4-[2,4-bis(trichloromethyl)-s-triazine-6-yl]phenylthio}acetate, 2-epoxyethyl-2-{4-[2,4-bis(trichloromethyl)-s-triazine-6-yl]phenylthio}acetate, cyclohexyl-2-(4-[2,4-bis(trichloromethyl)-s-triazine-6-yl]phenylthio)acetate, benzyl-2-{4-[2,4-bis(trichloromethyl)-s-triazine-6-yl]phenylthio}acetate, 3-{chloro-4-[2,4-bis(trichloromethyl)-s-triazine-6-yl]phenylthio}propionic acid, 3-{4-[2,4-bis(trichloromethyl)-s-triazine-6-yl]phenylthio}propionamide, 2,4-bis(trichloromethyl)-6-p-methoxystyryl-s-triazine, 2,4-bis(trichloromethyl)-6-(1-p-dimethylaminophenyl)-1,3,-butadienyl-s-triazine, or 2-trichloromethyl-4-amino-6-p-methoxystyryl-s-triazine.

According to embodiments of the disclosure, the initiator can be an azo compound, cyanovaleric-acid-based compound, peroxide, or a combination thereof. The azo compound can be 2,2′-azobis(2,4-dimethyl valeronitrile), dimethyl 2,2′-azobis(2-methylpropionate), 2,2-azobisisobutyronitrile (AIBN), 2,2-azobis(2-methylisobutyronitrile), 1,1′-azobis(cyclohexane-1-carbonitrile), 2,2′-azobis[N-(2-propenyl)-2-methylpropionamide], 1-[(cyano-1-methylethyl)azo]formamide, 2,2′-azobis(N-butyl-2-methylpropionamide), or 2,2′-azobis(N-cyclohexyl-2-methylpropionamide); the peroxide can be benzoyl peroxide, 1,1-bis(tert-butylperoxy)cyclohexane, 2,5-bis(tert-butylperoxy)-25-dimethylcyclohexane, 2,5-bis(tert-butylperoxy)-2,5-dimethyl-3-cyclohexyne, bis(1-(tert-butylpeorxy)-1-methy-ethyl)benzene, tert-butyl hydroperoxide, tert-butyl peroxide, tert-butyl peroxybenzoate, cumene hydroperoxide, cyclohexanone peroxide, dicumyl peroxide, or lauroyl peroxide. In some embodiments, the initiator can be ionic compound such as be lithium difluoro(oxalato)borate (LiBF₂(C₂O₄)) (LiDFOB).

According to embodiments of the disclosure, the composition for preparing the polymer can consist of the first monomer, the second monomer, and the initiator.

According to embodiments of the disclosure, the composition can be reacted at 50° C. to 150° C. for 60 minutes to 600 minutes to subject the composition to a polymerization, obtaining the polymer.

According to embodiments of the disclosure, the weight average molecular weight (Mw) of the polymer of the disclosure can be about 1,000 to 200,000, such as 2,000 to 150,000, or 3,000 to 100,000. For example, the weight average molecular weight (Mw) of the polymer of the disclosure is less than about 40,000, wherein the weight average molecular weight (Mw) of the polymer of the disclosure can be determined by gel permeation chromatography (GPC) based on a polystyrene calibration curve.

According to embodiments of the disclosure, the disclosure also provides an electrolyte, wherein the electrolyte includes a lithium salt, solvent, and aforementioned polymer, wherein the amount of polymer can be about 2 wt % to 20 wt % (such as about 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, or 19 wt %), based on the total weight of the solvent, lithium salt and polymer. When the amount of polymer is too high, the obtained electrolyte exhibits a lower ionic conductivity and higher interfacial impedance. When the amount of polymer is too low, the flame retardance of the obtained electrolyte would not be improved, and the obtained electrolyte cannot exhibit an ability to inhibit oxidation at high voltage.

According to embodiments of the disclosure, the concentration of lithium salt dissolved in the solvent is about from 0.8M to 1.6M, such as about 0.9M, 1.0M, 1.1M, 1.2M, 1.3M, 1.4M, or 1.5M.

According to embodiments of the disclosure, the preparation of electrolyte includes the following steps. First, a lithium salt, a solvent, and a composition are mixed to obtain a mixture. Next, the mixture is subjected to a heating process (having a temperature of 50° C. to 150° C. and a time period of 60 minutes to 600 minutes), obtaining the electrolyte of the disclosure. According to embodiments of the disclosure, the composition includes the first monomer, and the second monomer. According to embodiments of the disclosure, the composition includes the first monomer, the second monomer, and the initiator. According to embodiments of the disclosure, the composition consists of the first monomer, the second monomer, and the initiator.

According to embodiments of the disclosure, the weight ratio of the lithium salt to the solvent can be about 1:19 to 7:13, such as about 2:18, 3:17, 416, 5:15, or 6:14. According to embodiments of the disclosure, the lithium salt is lithium hexafluorophosphate (LiPF₆), lithium perchlorate (LiClO₄), bis(fluorosulfonyl)imide lithium (LiN(SO₂F)₂) (LiFSI), lithium difluoro(oxalato)borate (LiBF₂(C₂O₄)) (LiDFOB), lithium tetrafluoroborate (LiBF₄), lithium trifluoromethanesulfonate (Li SO₃CF₃), bis(trifluoromethane)sulfonimide lithium (LiN(SO₂CF₃)₂) (LiTFSI), lithium bis perfluoroethanesulfonimide (LiN(SO₂CF₂CF₃)₂), lithium hexafluoroarsenate (LiAsF₆), lithium hexafluoroantimonate (LiSbF₆), lithium tetrachloroaluminate (LiAlCl₄), lithium tetrachlorogallate (LiGaCl₄), lithium nitrate (LiNO₃), tris(trifluoromethanesulfonyl)methyllithium (LiC(SO₂CF₃)₃), lithium thiocyanate hydrate (LiSCN), LiO₃SCF₂CF₃, LiC₆F₅SO₃, LiO₂CCF₃, lithiumfluorosulfonate (LiSO₃F), lithium tetrakis(pentafluorophenyl)borate, (LiB(C₆H₅)₄), lithium bis(oxalato)borate (LiB(C₂O₄)₂) (LiBOB), or a combination thereof.

According to embodiments of the disclosure, the solvent can be organic solvent, such as ester solvent, ketone solvent, carbonate solvent, ether solvent, alkane solvent, amide solvent, or a combination thereof. According to embodiments of the disclosure, the solvent can be 1,2-diethoxyethane, 1,2-dimethoxyethane, 1,2-dibutoxyethane, tetrahydrofuran (THF), 2-methyl tetrahydrofuran, dimethylacetamide (DMAc), N-methyl-2-pyrrolidone (NMP), methyl acetate, ethyl acetate, methyl butyrate, ethyl butyrate, methyl proionate, ethyl proionate, propyl acetate (PA), γ-butyrolactone (GBL), ethylene carbonate (EC), propylene carbonate (PC), diethyl carbonate (DEC), ethylmethyl carbonate (EMC), dimethyl carbonate (DMC), vinylene carbonate, butylene carbonate, 1,3-propanesultone, dipropyl carbonate, or a combination thereof.

According to embodiments of the disclosure, the disclosure also provides a lithium-ion battery including aforementioned electrolyte. As shown in FIGURE, the lithium-ion battery 100 includes a negative electrode 10, a positive electrode 20, and a separator 30, wherein the negative electrode 10 is separated from the positive electrode 20 by the separator 30. According to embodiments of the disclosure, the battery 100 can include an electrolyte 40, and the electrolyte 40 is disposed between the negative electrode 10 and the positive electrode 20. Namely, the structure stacked by the negative electrode 10, separator 30 and the positive electrode 20 is immersed in the electrolyte 40. According to embodiments of the disclosure, the electrolyte 40 is dispersed throughout the battery 100.

According to embodiments of the disclosure, the negative electrode 10 includes a negative electrode active layer, wherein the negative electrode active layer includes a negative electrode active material. According to embodiments of the disclosure, the negative electrode active material can be lithium metal, lithium alloy, transition metal oxide, metastable phase spherical carbon (MCMB), vapor-grown carbon fiber (VGCF), carbon nanotube (CNT), graphene, coke, graphite (such as artificial graphite or natural graphite), carbon black, acetylene black, carbon fiber, mesophase carbon microbead, glassy carbon, lithium-containing compound, silicon-containing compound, tin, tin-containing compound, or a combination thereof. According to embodiments of the disclosure, the lithium-containing compound can include LiAl, LiMg, LiZn, Li₃Bi, Li₃Cd, Li₃Sb, Li₄Si, Li_{4.4}Pb, Li_{4.4}Sn, LiC₆, Li₃FeN₂, Li_{2.6}Co_{0.4}N, or Li_{2.6}Cu_{0.4}N. According to embodiments of the disclosure, the silicon-containing compound can include silicon oxide, carbon-modified silicon oxide, silicon carbide, pure-silicon material, or a combination thereof. According to embodiments of the disclosure, the tin-containing compound can include tin antimony alloy (SnSb) or tin oxide (SnO). According to embodiments of the disclosure, transition metal oxide can include Li₄Ti₅O₁₂ or TiNb₂O₇. According to embodiments of the disclosure, the lithium alloy can be aluminum-lithium-containing alloy, lithium-magnesium-containing alloy, lithium-zinc-containing alloy, lithium-lead-containing alloy, or lithium-tin-containing alloy.

According to embodiments of the disclosure, the negative electrode active layer can further include a conductive additive, wherein the conductive additive can be carbon black, conductive graphite, carbon nanotube, carbon fiber, or graphene. According to embodiments of the disclosure, the negative electrode active layer can further include a binder, wherein the binder can include polyvinyl alcohol (PVA), polytetrafluoroethylene (PTFE), sodium carboxymethyl cellulose, polyvinylidene fluoride (PVDF), styrene-butadiene copolymer, fluorinated rubber, polyurethane, polyvinyl pyrrolidone, poly(ethyl acrylate), polyvinylchloride (PVC), polyacrylonitrile (PAN), polybutadiene, polyacrylic acid (PAA), or a combination thereof.

According to embodiments of the disclosure, the negative electrode 10 can further include a negative electrode current-collecting layer, and the negative electrode active material is disposed on the negative electrode current-collecting layer. According to embodiments of the disclosure, the negative electrode active material is disposed between the separator and the negative electrode current-collecting layer. According to embodiments of the disclosure, the negative electrode current-collecting layer can be a conductive carbon substrate, metal foil, or metal material with a porous structure, such as carbon cloth, carbon felt, carbon paper, copper foil, nickel foil, aluminum foil, nickel mesh, copper mesh, molybdenum mesh, nickel foam, copper foam, or molybdenum foam. According to embodiments of the disclosure, the metal material with a porous structure can have a porosity P from about 10% to 99.9% (such as about 60% or 70%).

According to embodiments of the disclosure, the negative electrode active layer can be prepared from a negative electrode slurry. According to embodiments of the disclosure, the negative electrode slurry can include a negative electrode active material, conductive additive, binder, and solvent, wherein the negative electrode active material, conductive additive, binder are dispersed in the solvent, wherein the solid content of the negative electrode slurry can be from 40 wt % to 80 wt %. According to embodiments of the disclosure, the method for preparing the negative electrode can include the following steps. First, the negative electrode slurry is coated on a surface of the negative electrode current-collecting layer via a coating process to form a coating. Next, the coating is subjected to a drying process (at a temperature from 50° C. to 180° C.), obtaining a negative electrode with a negative electrode active layer. According to embodiments of the disclosure, the solvent can be 1-methyl-2-pyrrolidinone (NMP), N, N-dimethylformamide (DMF), N, N-dimethylacetamide (DMAc), pyrrolidone, N-dodecylpyrrolidone, γ-butyrolactone, water, or a combination thereof. According to embodiments of the disclosure, the coating process can be screen printing, spin coating, bar coating, blade coating, roller coating, solvent casting, or dip coating.

According to embodiments of the disclosure, in the negative electrode active layer, the negative electrode active material can have a weight percentage of about 80 wt % to 99.8 wt %, the conductive additive can have a weight percentage of about 0.1 wt % to 10 wt %, and the binder can have a weight percentage of about 0.1 wt % to 10 wt %, based on the total weight of the negative electrode material, the conductive additive, and the binder.

According to embodiments of the disclosure, the positive electrode 10 includes a positive electrode active layer, wherein the positive electrode active layer includes a positive electrode active material. According to embodiments of the disclosure, the positive electrode active material can be elementary sulfur, organic sulfide, sulfur carbon composite, metal-containing lithium oxide, metal-containing lithium sulfide, metal-containing lithium selenide, metal-containing lithium telluride, metal-containing lithium phosphide, metal-containing lithium silicide, metal-containing lithium boride, or a combination thereof, wherein the metal is selected from a group consisting of aluminum, vanadium, titanium, chromium, copper, molybdenum, niobium, iron, nickel, cobalt, and manganese. According to embodiments of the disclosure, the positive electrode material can be lithium-cobalt oxide, lithium-nickel oxide, lithium-manganese oxide, lithium-cobalt manganese oxide, lithium-nickel-cobalt oxide, lithium-manganese-nickel oxide, lithium-nickel-manganese-cobalt oxide, lithium-cobalt phosphate, lithium-chromium-manganese oxide, lithium-nickel-vanadium oxide, lithium-manganese-nickel oxide, lithium-cobalt-vanadium oxide, lithium-nickel-cobalt-aluminum oxide, lithium-iron phosphate, lithium-manganese-iron phosphate, or a combination thereof.

According to embodiments of the disclosure, the positive electrode active layer can further include a conductive additive, wherein the conductive additive can be carbon black, conductive graphite, carbon nanotube, carbon fiber, or graphene. According to embodiments of the disclosure, the positive electrode active layer can further include a binder, wherein the binder can include polyvinyl alcohol (PVA), polytetrafluoroethylene (PTFE), sodium carboxymethyl cellulose, polyvinylidene fluoride (PVDF), styrene-butadiene copolymer, fluorinated rubber, polyurethane, polyvinyl pyrrolidone, poly(ethyl acrylate), polyvinylchloride (PVC), polyacrylonitrile (PAN), polybutadiene, polyacrylic acid (PAA), or a combination thereof.

According to embodiments of the disclosure, the positive electrode can further include a positive electrode current-collecting layer, and the positive electrode active material is disposed on the positive electrode current-collecting layer. According to embodiments of the disclosure, the positive electrode active material can be disposed between the separator and the positive electrode current-collecting layer. According to embodiments of the disclosure, the positive electrode current-collecting layer can be conductive carbon substrate, metal foil, or metal material with a porous structure, such as carbon cloth, carbon felt, carbon paper, copper foil, nickel foil, aluminum foil, nickel mesh, copper mesh, molybdenum mesh, nickel foam, copper foam, or molybdenum foam. According to embodiments of the disclosure, the metal material with a porous structure can have a porosity P from about 10% to 99.9% (such as about 60% or 70%).

According to embodiments of the disclosure, the positive electrode active layer can be prepared from a positive electrode slurry. According to embodiments of the disclosure, the positive electrode slurry can include a positive electrode active material, conductive additive, binder, and solvent, wherein the positive electrode active material, conductive additive, binder are dispersed in the solvent, wherein the solid content of the positive electrode slurry can be from 40 wt % to 80 wt %. According to embodiments of the disclosure, the method for preparing the positive electrode can include the following steps. First, the positive electrode slum is coated on a surface of the positive electrode current-collecting layer via a coating process to form a coating.

Next, the coating is subjected to a drying process (at a temperature from 50° C. to 180° C.), obtaining a positive electrode with a positive electrode active layer.

According to embodiments of the disclosure, the solvent can be 1-methyl-2-pyrrolidinone (NMP), N, N-dimethylformamide (DMF), N, N-dimethylacetamide (DMAc), pyrrolidone, N-dodecylpyrrolidone, γ-butyrolactone, water, or a combination thereof. According to embodiments of the disclosure, the coating process can be screen printing, spin coating, bar coating, blade coating, roller coating, solvent casting, or dip coating.

According to embodiments of the disclosure, in the positive electrode active layer, the positive electrode active material can have a weight percentage of about 80 wt % to 99.8 wt %, the conductive additive can have a weight percentage of about 0.1 wt % to 10 wt %, and the binder can have a weight percentage of about 0.1 wt % to 10 wt %, based on the total weight of the positive electrode material, the conductive additive, and the binder.

According to embodiments of the disclosure, the separator 30 can be insulating material, such as polyethylene (PE), polypropylene (PP), polytetrafluoroethylene (PTFE) film, polyamide film, polyvinyl chloride (PVC) film, poly(vinylidene fluoride) film, polyaniline film, polyimide film, polyethylene terephthalate, polystyrene (PS), cellulose, or a combination thereof. For example, the separator can be PE/PP/PE multilayer composite structure. According to embodiments of the disclosure, the thickness of the separator is not limited and can be optionally modified by a person of ordinary skill in the field. According to embodiments of the disclosure, the thickness of the separator 30 can be of about 1 μm to 1,000 μm (such as about 10 μm, 50 μm, 100 μm, 200 μm, 300 μm, 400 μm, 500 μm, 60 μm, 700 μm 800 μm, or 900 μm). When the thickness of the separator is too high, the energy density of the battery is reduced. When the thickness of the separator is too low, the short-circuit occurrence between the positive electrode and negative electrode would be increased, the self-discharge rate of the battery is increased, and the cycling stability of the battery is affected due to the insufficient mechanical strength of the separator.

Below, exemplary embodiments will be described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLE

Preparation of Polymer

### Example 1

50 parts by weight of tris[2-(acryloyloxy)ethyl]isocyanurate, 50 parts by weight of perfluorobutyl ethylene, and 0.5 parts by weight of 2,2-azobisisobutyronitrile (AIBN) were dissolved in acetonitrile, obtaining a solution. The solid content of the solution was 30 wt %. Next, the solution was heated to 70° C. for 2 hours, obtaining a polymer.

Next, the measurement results of nuclear magnetic resonance spectrometry of the polymer of Example 1 are shown below: ¹H NMR (CDCl₃, 500 MHz) 4.32-4.37 (m), 3.42-3.47 (m), 2.24-2.30 (m), 1.66-1.70 (m), 1.60-1.64 (m), 1.27-1.32 (m), 1.12-1.17 (m).

Electrolyte

### Example 2

89.95 wt % of a standard electrolyte liquid (commercially available from Formosa Plastics Corporation, with a trade designation of EED352) (consisting of 20 wt % of diethyl carbonate, 4 wt % of propylene carbonate. 18 wt % of dimethyl carbonate, 15 wt % of ethyl methyl carbonate, 22 wt % of ethylene carbonate. 6 wt % of 1,3-propane sultone, and 15 wt % of lithium hexafluorophosphate), 5 wt % of tris[2-(acryloyloxy)ethyl]isocyanurate, 5 wt % of perfluorobutyl ethylene, and 0.05 wt % of 2,2-azobisisobutyronitrile (AIBN) were mixed, obtaining a mixture. Next, the mixture was heated to 70° C. for 2 hours, thereby forcing tris[2-(acryloyloxy)ethyl]isocyanurate to react with perfluorobutyl ethylene to undergo a polymerization, obtaining an electrolyte.

Next, the electrolyte of Example 2 and the standard electrolyte liquid (commercially available from Formosa Plastics Corporation, with a trade designation of EED352) were tried to be ignited by an ignition gun. It could be observed that the electrolyte of Example 2 cannot be ignited, and the standard electrolyte liquid can be easily ignited and burned continuously

Lithium-Ion Battery

### Example 3

A standard lithium-ion battery positive electrode slurry (including 97.3 wt % of NMC811 (LiNiⱼMnⱼCoₖO₂, wherein is 0.83-0.85; j: 0.4-0.5; k: 0.11-0.12) (commercially available from Ningbo Ronbay New Energy Technology Co., Ltd. with a trade designation of NMC811-S85E), 1 wt % of Super-P (conductive carbon, commercially available from Timcal), 1.4 wt % of PVDF-5130, and 0.3 wt % of carbon nanotube (commercially available from OCSiAl with a trade designation of TUBALL™ BATT), wherein NMC811-S85E, Super-P, PVDF-5130, carbon nanotube were uniformly dispersed in n-methyl-2-pyrrolidone (NMP)) was coated on an aluminum foil (serving as the positive electrode current-collecting layer) (commercially available from An Chuan Enterprise Co., Ltd., with a thickness of 12 μm). After drying, a positive electrode was obtained.

Next, a standard negative electrode slurry (including 96.3 wt % of SiO/C (a mixture of silicon oxide and carbon) (commercially available from Kaijin New Energy Technology Co., Ltd. with a trade designation of KYX-2), 0.3 wt % of Super-P (conductive carbon, commercially available from Timcal), 1.5 wt % of styrene butadiene rubber (SBR) (commercially available from JSR), 1.3 wt % of carboxymethyl cellulose (CMC) (commercially available from Daicel Chemical industries with a trade designation of CMC-2200), and 0.6 wt % of carbon nanotube (commercially available from OCSiAl with a trade designation of TUBALL™), wherein SiO/C, Super-P, SBR, CMC, and carbon nanotube were dispersed in deionized water) was coated on an copper foil (commercially available from Chang Chun Group with a trade designation of BFR—F) (with a thickness of 12 μm). After drying, a negative electrode was obtained. Next, a separator (available under the trade designation of Celgard 2320, AsahiKasei) was provided.

Next, the negative electrode, the separator, and the positive electrode were placed in sequence and sealed within a coin-type cell. Next, a mixture (including 89.95 wt % of the standard electrolyte liquid (commercially available from Formosa Plastics Corporation, with a trade designation of EED352) (consisting of 20 wt % of diethyl carbonate. 4 wt % of propylene carbonate. 18 wt % of dimethyl carbonate, 15 wt % of ethyl methyl carbonate, 22 wt % of ethylene carbonate. 6 wt % of 1,3-propane sultone, and 15 wt % of lithium hexafluorophosphate), 5 wt % of tris[2-(acryloyloxy)ethyl]isocyanurate. 5 wt % of perfluorobutyl ethylene, and 0.05 wt % of 2,2-azobisisobutyronitrile) was injected into the coin-type cell. After packaging and heating to 70° C. for 2 hours (i.e. altering the mixture into the electrolyte), the coin-type battery (CR2032) (with a size of 3.2 mm (thickness)×20 mm (width)×20 mm (length)) was obtained. Next, the oxidation current (mA) at high voltage and the capacity retention (%) of the battery were measured, and the results are shown in Table 1.

The oxidation current (mA) at high voltage was measured by Linear Sweep Voltammetry (LSV) and the conditions of measurement are shown below. The scanning rate is 10 mV/s, and the voltage range is 3.0V to 5.5V, and the current value of 5.5V is recorded. The oxidation activity of electrolyte at high voltage is directly proportional to the oxidation current, and the stability of the electrolyte is inversely proportional to the oxidation current. The capacity retention was measured by determining the discharge specific capacity at the first charge/discharge cycle and the discharge specific capacity at the 80th charge/discharge cycle (at charge rate and discharge rate of 0.5 C/1 C).

### Comparative Example 1

The negative electrode and the positive electrode were provided. Next, a separator (available under the trade designation of Celgard 2320. AsahiKasei) was provided. Next, the negative electrode, the separator, and the positive electrode were placed in sequence and sealed within a coin-type cell and a standard electrolyte liquid (commercially available from Formosa Plastics Corporation, with a trade designation of EED352) was injected into the coin-type cell, obtaining the coin-type battery (CR2032) (with a size of 3.2 mm (thickness)×20 mm (width)×20 mm (length)). Next, the oxidation current (mA) at high voltage and the capacity retention (%) of the battery were measured, and the results are shown in Table 1.

### Comparative Example 2

The negative electrode and the positive electrode were provided. Next, a separator (available under the trade designation of Celgard 2320, AsahiKasei) was provided. Next, the negative electrode, the separator, and the positive electrode were placed in sequence and sealed within a coin-type cell, and 94. 95 wt % of the standard electrolyte liquid (commercially available from Formosa Plastics Corporation, with a trade designation of EED352), 5 wt % of tris[2-(acryloyloxy)ethyl]isocyanurate, and 0.05 wt % of 2,2-azobisisobutyronitrile were injected into the coin-type cell. After packaging and heating to 70° C. for 2 hours, the coin-type battery (CR2032) (with a size of 3.2 mm (thickness)×20 mm (width)×20 mm (length)) was obtained. Next, the oxidation current (mA) at high voltage and the capacity retention (%) of the battery were measured, and the results are shown in Table 1.

### Comparative Example 3

The negative electrode and the positive electrode were provided. Next, a separator (available under the trade designation of Celgard 2320, AsahiKasei) was provided. Next, the negative electrode, the separator, and the positive electrode were placed in sequence and sealed within a coin-type cell, and 95 wt % of the standard electrolyte liquid (commercially available from Formosa Plastics Corporation, with a trade designation of EED352) and 5 wt % of perfluorobutyl ethylene were injected into the coin-type cell. After packaging, the con-type battery (CR2032) (with a size of 3.2 mm (thickness)×20 mm (width)×20 mm (length)) was obtained. Next, the oxidation current (mA) at high voltage and the capacity retention (%) of the battery were measured, and the results are shown in Table 1.

TABLE 1

| | | tris[2- | | | capacity | |
|---|---|---|---|---|---|---|
| | standard | (acryloyloxy) | perfluoro- | | retention (%) | |
| | electrolyte | ethyl]iso- | butyl | | (80th charge/ | oxidation |
| | liquid | cyanurate | ethylene | initiator | discharge | current(mA) |
| | (wt %) | (wt %) | (wt %) | (wt %) | cycle) | (5.5 V) |
| Comparative | 100 | 0 | 0 | 0 | ~70 | 0.060 |
| Example 1 | | | | | | |
| Comparative | 94.95 | 5 | 0 | 0.05 | ~74 | 0.022 |
| Example 2 | | | | | | |
| Comparative | 95 | 0 | 5 | 0 | ~14 | 0.170 |
| Example 3 | | | | | | |
| Example 3 | 89.95 | 5 | 5 | 0.05 | ~82 | 0.010 |

As shown in Table 1, in comparison with the battery of Comparative Example 1 (employing the standard electrolyte liquid), the oxidation current of the battery of Example 3 (employing the electrolyte of the disclosure) is reduced obviously, and the capacity retention of the battery is greater than 80%. Although the composition for preparing the electrolyte of Comparative Example 2 further includes tris[2-(acryloyloxy)ethyl]isocyanurate and initiator for use in concert with the standard electrolyte liquid, the composition for preparing the electrolyte of Comparative Example 2 does not include perfluorobutyl ethylene. Therefore, the obtained polymer in the electrolyte of Comparative Example 2 does not have fluorine atoms, resulting in higher oxidation current at high voltage, and lower capacity retention (in comparison with the battery of Example 3).

### Example 4

The negative electrode and the positive electrode of Example 3 were provided. Next, a separator (available under the trade designation of Celgard 2320, AsahiKasei) was provided. Next, the negative electrode, the separator, and the positive electrode were placed in sequence and sealed within a coin-type cell. Next, a mixture (including 91.96 wt % of the standard electrolyte liquid (commercially available from Formosa Plastics Corporation, with a trade designation of EED352), 4 wt % of tris[2-(acryloyloxy)ethyl]isocyanurate, 4 wt % of perfluorobutyl ethylene, and 0.04 wt % of 2,2-azobisisobutyronitrile) were injected into the coin-type cell. After packaging and heating to 70° C. for 2 hours (i.e. altering the mixture into the electrolyte), the coin-type battery (CR2032) (with a size of 3.2 mm (thickness)×20 mm (width)×20 mm (length)) was obtained. Next, the discharge capacity of batteries of Comparative Example 1, Comparative Example 2 and Example 4 were measured at discharge rate of 2 C, and the results are shown in Table 2. Next, the oxidation current (mA) at high voltage and the capacity retention (%) of the battery were measured, and the results are shown in Table 3.

TABLE 2

| | Comparative | Comparative | |
|---|---|---|---|
| | Example 1 | Example 2 | Example 4 |
| discharge | ~107 | ~97 | ~118 |
| capacity | | | |
| (mAh/g) | | | |

As shown in Table 2, in comparison with the battery of Comparative Example 1 (employing the standard electrolyte liquid), the battery of Example 4 (employing the electrolyte of the disclosure) exhibits a higher discharge capacity. It means that the electrolyte of the disclosure can indeed improve the high C-rate discharge ability of the battery. Although the composition for preparing the electrolyte of Comparative Example 2 further includes tris[2-(acryloyloxy)ethyl]isocyanurate and initiator for use in concert with the standard electrolyte liquid, the composition for preparing the electrolyte of Comparative Example 2 does not include perfluorobutyl ethylene. Therefore, the obtained polymer in the electrolyte of Comparative Example 2 has a dense (or rigid) network structure, which is not apt to adsorb the lithium salt and solution, thereby reducing the ionic conductivity of the standard electrolyte liquid.

### Example 5

The negative electrode and the positive electrode of Example 3 were provided. Next, a separator (available under the trade designation of Celgard 2320, AsahiKasei) was provided. Next, the negative electrode, the separator, and the positive electrode were placed in sequence and sealed within a coin-type cell. Next, a mixture (including 93.96 wt % of the standard electrolyte liquid (commercially available from Formosa Plastics Corporation, with a trade designation of EED352), 4 wt % of tris[2-(acryloyloxy)ethyl]isocyanurate, 2 wt % of perfluorobutyl ethylene, and 0.04 wt % of 2,2-azobisisobutyronitrile) were injected into the coin-type cell. After packaging and heating to 70° C. for 2 hours (i.e. altering the mixture into the electrolyte), the coin-type battery (CR2032) (with a size of 3.2 mm (thickness)×20 mm (width)×20 mm (length)) was obtained. Next, the oxidation current (mA) at high voltage and the capacity retention (%) of the battery were measured, and the results are shown in Table 3.

### Example 6

The negative electrode and the positive electrode of Example 3 were provided. Next, a separator (available under the trade designation of Celgard 2320, AsahiKasei) was provided. Next, the negative electrode, the separator, and the positive electrode were placed in sequence and sealed within a coin-type cell. Next, a mixture (including 94.97 wt % of the standard electrolyte liquid (commercially available from Formosa Plastics Corporation, with a trade designation of EED352), 3 wt % of tris[2-(acryloyloxy)ethyl]isocyanurate, 2 wt % of perfluorobutyl ethylene, and 0.03 wt % of 2,2-azobisisobutyronitrile) were injected into the coin-type cell. After packaging and heating to 70° C. for 2 hours (i.e. altering the mixture into the electrolyte), the coin-type battery (CR2032) (with a size of 3.2 mm (thickness)×20 mm (width)×20 mm (length)) was obtained. Next, the oxidation current (mA) at high voltage and the capacity retention (%) of the battery were measured, and the results are shown in Table 3.

### Example 7

The negative electrode and the positive electrode of Example 3 were provided. Next, a separator (available under the trade designation of Celgard 2320, AsahiKasei) was provided. Next, the negative electrode, the separator, and the positive electrode were placed in sequence and sealed within a coin-type cell, and 90.96 wt % of the standard electrolyte liquid (commercially available from Formosa Plastics Corporation, with a trade designation of EED352), 4 wt % of tris[2-(acryloyloxy)ethyl]isocyanurate, 5 wt % of perfluorobutyl ethylene, and 0.04 wt % of 2,2-azobisisobutyronitrile were injected into the coin-type cell. After packaging and heating to 70° C. for 2 hours (i.e. altering the mixture into the electrolyte), the coin-type battery (CR2032) (with a size of 3.2 mm (thickness)×20 mm (width)×20 mm (length)) was obtained. Next, the oxidation current (mA) at high voltage and the capacity retention (%) of the battery were measured, and the results are shown in Table 3.

### Example 8

The negative electrode and the positive electrode of Example 3 were provided. Next, a separator (available under the trade designation of Celgard 2320. AsahiKasei) was provided. Next, the negative electrode, the separator, and the positive electrode were placed in sequence and sealed within a coin-type cell, and 89.96 wt % of the standard electrolyte liquid (commercially available from Formosa Plastics Corporation, with a trade designation of EED352), 4 wt % of tris[2-(acryloyloxy)ethyl]isocyanurate, 6 wt % of perfluorobutyl ethylene, and 0.04 wt % of 2,2-azobisisobutyronitrile were injected into the coin-type cell. After packaging and heating to 70° C. for 2 hours (i.e. altering the mixture into the electrolyte), the coin-type battery (CR2032) (with a size of 3.2 mm (thickness)×20 mm (width)×20 mm (length)) was obtained. Next, the oxidation current (mA) at high voltage and the capacity retention (%) of the battery were measured, and the results are shown in Table 3.

### Example 9

The negative electrode and the positive electrode of Example 3 were provided. Next, a separator (available under the trade designation of Celgard 2320, AsahiKasei) was provided. Next, the negative electrode, the separator, and the positive electrode were placed in sequence and sealed within a coin-type cell, and 85.93 wt % of the standard electrolyte liquid (commercially available from Formosa Plastics Corporation, with a trade designation of EED352), 7 wt % of tris[2-(acryloyloxy)ethyl]isocyanurate, 7 wt % of perfluorobutyl ethylene, and 0.07 wt % of 2,2-azobisisobutyronitrile were injected into the coin-type cell. After packaging and heating to 70° C. for 2 hours (i.e. altering the mixture into the electrolyte), the coin-type battery (CR2032) (with a size of 3.2 mm (thickness)×20 mm (width)×20 mm (length)) was obtained. Next, the oxidation current (mA) at high voltage and the capacity retention (%) of the battery were measured, and the results are shown in Table 3.

### Example 10

The negative electrode and the positive electrode of Example 3 were provided. Next, a separator (available under the trade designation of Celgard 2320, AsahiKasei) was provided. Next, the negative electrode, the separator, and the positive electrode were placed in sequence and sealed within a coin-type cell, and 93.95 wt % of the standard electrolyte liquid (commercially available from Formosa Plastics Corporation, with a trade designation of EED352), 5 wt % of tris[2-(acryloyloxy)ethyl]isocyanurate, 1 wt % of perfluorobutyl ethylene, and 0.05 wt % of 2,2-azobisisobutyronitrile were injected into the coin-type cell. After packaging and heating to 70° C. for 2 hours (i.e. altering the mixture into the electrolyte), the coin-type battery (CR2032) (with a size of 3.2 mm (thickness)×20 mm (width)×20 mm (length)) was obtained. Next, the oxidation current (mA) at high voltage and the capacity retention (%) of the battery were measured, and the results are shown in Table 3.

### Example 11

The negative electrode and the positive electrode of Example 3 were provided. Next, a separator (available under the trade designation of Celgard 2320, AsahiKasei) was provided. Next, the negative electrode, the separator, and the positive electrode were placed in sequence and sealed within a coin-type cell, and 93.98 wt % of the standard electrolyte liquid (commercially available from Formosa Plastics Corporation, with a trade designation of EED352), 2 wt % of tris[2-(acryloyloxy)ethyl]isocyanurate, 4 wt % of perfluorobutyl ethylene, and 0.02 wt % of 2,2-azobisisobutyronitrile were injected into the coin-type cell. After packaging and heating to 70° C. for 2 hours (i.e. altering the mixture into the electrolyte), the coin-type battery (CR2032) (with a size of 3.2 mm (thickness)×20 mm (width)×20 mm (length)) was obtained. Next, the oxidation current (mA) at high voltage and the capacity retention (%) of the battery were measured, and the results are shown in Table 3.

### Example 12

The negative electrode and the positive electrode of Example 3 were provided. Next, a separator (available under the trade designation of Celgard 2320. AsahiKasei) was provided. Next, the negative electrode, the separator, and the positive electrode were placed in sequence and sealed within a coin-type cell, and 79 wt % of the standard electrolyte liquid (commercially available from Formosa Plastics Corporation, with a trade designation of EED352), 10.45 wt % of tris[2-(acryloyloxy)ethyl]isocyanurate, 10.45 wt % of perfluorobutyl ethylene, and 0.1 wt % of 2,2-azobisisobutyronitrile were injected into the coin-type cell. After packaging and heating to 70° C. for 2 hours (i.e. altering the mixture into the electrolyte), the coin-type battery (CR2032) (with a size of 3.2 mm (thickness)×20 mm (width)×20 mm (length)) was obtained. Next, the oxidation current (mA) at high voltage and the capacity retention (%) of the battery were measured, and the results are shown in Table 3.

TABLE 3

| | | tris[2- | | | capacity | |
|---|---|---|---|---|---|---|
| | standard | (acryloyl- | perfluoro- | | retention (%) | |
| | electrolyte | oxy)ethyl]iso- | butyl | | (80th charge/ | oxidation |
| | liquid | cyanurate | ethylene | initiator | discharge | current(mA) |
| | (wt %) | (wt %) | (wt %) | (wt %) | cycle) | (5.5 V) |
| Example 4 | 91.96 | 4 | 4 | 0.04 | ~92 | 0.005 |
| Example 5 | 93.96 | 4 | 2 | 0.04 | ~90 | 0.013 |
| Example 6 | 94.97 | 3 | 2 | 0.03 | ~88 | 0.017 |
| Example 7 | 90.96 | 4 | 5 | 0.04 | ~91 | 0.007 |
| Example 8 | 89.96 | 4 | 6 | 0.04 | ~91 | 0.008 |
| Example 9 | 85.93 | 7 | 1 | 0.07 | ~80 | 0.003 |
| Example 10 | 93.95 | 5 | 1 | 0.05 | ~80 | 0.020 |
| Example 11 | 93.98 | 2 | 4 | 0.02 | ~80 | 0.019 |
| Example 12 | ~79.00 | ~10.45 | ~10.45 | 0.1 | ~75 | — |

### Example 13

Example 13 was performed in the same manner as in Example 4, except that perfluorobutyl ethylene was replaced with 1H, 1H, 5H-octafluoropentyl acrylate, obtaining the battery. Next, the oxidation current (mA) at high voltage and the capacity retention (%) of the battery were measured, and the results are shown in Table 4.

TABLE 4

| | | tris[2- | 1H,1H,5H- | | capacity | |
|---|---|---|---|---|---|---|
| | standard | (acryloyloxy) | octafluoro- | | retention (%) | |
| | electrolyte | ethyl]iso- | pentyl | | (80th charge/ | oxidation |
| | liquid | cyanurate | acrylate | initiator | discharge | current(mA) |
| | (wt %) | (wt %) | (wt %) | (wt %) | cycle) | (5.5 V) |
| Comparative | 100 | 0 | 0 | 0 | ~70 | 0.060 |
| Example 1 | | | | | | |
| Example 13 | 91.96 | 4 | 4 | 0.04 | ~80 | 0.009 |

As shown in Table 4, in comparison with the battery of Comparative Example (employing the standard electrolyte liquid), the oxidation current of the battery of Example 13 (employing the electrolyte of the disclosure) is reduced obviously, and the capacity retention of the battery is greater than 80%.

### Example 14

The negative electrode and the positive electrode of Example 3 were provided. Next, a separator (available under the trade designation of Celgard 2320, AsahiKasei) was provided. Next, the negative electrode, the separator, and the positive electrode were placed in sequence and sealed within a coin-type cell, and 93 wt % of the standard electrolyte liquid (commercially available from Formosa Plastics Corporation, with a trade designation of EED352), 3 wt % of triglycidyl isocyanurate(triglycidyl isocyanurate). 2 wt % of 3-perfluorooctyl-1,2-epoxypropane, and 2 wt % of lithium difluoro(oxalato)borate (LiDFOB) were injected into the coin-type cell. After packaging and heating to 55° C. for 10 hours (i.e. altering the mixture into the electrolyte), the coin-type battery (CR2032) (with a size of 3.2 mm (thickness)×20 mm (width)×20 mm (length)) was obtained. Next, the oxidation current (mA) at high voltage and the capacity retention (%) of the battery were measured, and the results are shown in Table 5.

TABLE 5

| | | | | | capacity | |
|---|---|---|---|---|---|---|
| | standard | | 3-perfluoro- | lithium | retention (%) | |
| | electrolyte | triglycidyl | octyl-1,2- | difluoro(oxa- | (80th charging/ | oxidation |
| | liquid | isocyanurate | epoxypropane | lato)borate | discharging | current(mA) |
| | (wt %) | (wt %) | (wt %) | (wt %) | cycl) | (5.5 V) |
| Comparative | 100 | 0 | 0 | 0 | ~70 | 0.060 |
| Example 1 | | | | | | |
| Example 14 | 93 | 3 | 2 | 2 | ~88 | 0.003 |

As shown in Table 5, in comparison with the battery of Comparative Example 1 (employing the standard electrolyte liquid), the oxidation current of the battery of Example 14 (employing the electrolyte of the disclosure) is reduced obviously, and the capacity retention of the battery is greater than 80%.

Accordingly, the quasi-solid electrolyte, which has specific ingredients, of the disclosure exhibits a better flame retardance and an ability to inhibit oxidation at high voltage. As a result, the performance, C-rate discharge ability and safety in use of the lithium-ion battery at high voltage could be improved, and the life cycle of the lithium-ion battery could be prolonged.

It will be clear that various modifications and variations can be made to the disclosed methods and materials. It is intended that the specification and examples be considered as exemplary only, with the true scope of the disclosure being indicated by the following claims and their equivalents.

What is claimed is:

1. A polymer, which is a product of a composition via a polymerization, wherein the composition comprises a first monomer and a second monomer, wherein the first monomer has a structure represented by Formula (I), and the second monomer is fluorine-containing acrylate, fluorine-containing alkene, fluorine-containing epoxide, or a combination thereof 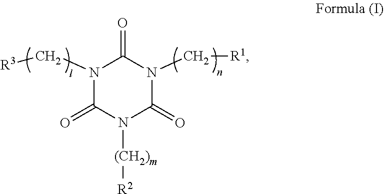
wherein n, m, and l are independently 1, 2, 3, 4, 5, or 6; R¹, R², and R³ are independently —OH, 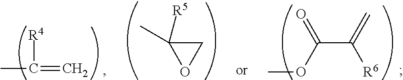
and, R⁴, R⁵, and R⁶ are independently hydrogen or C₁₋₃ alkyl group.

2. The polymer as claimed in claim 1, wherein the weight ratio of the first monomer to the second monomer is 5:1 to 1:2.

3. The polymer as claimed in claim 1, wherein the fluorine-containing acrylate has a structure represented by Formula (II) or Formula (III) 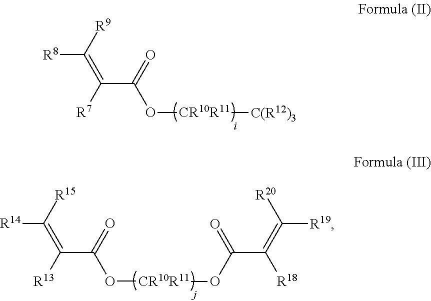
wherein i is 0; 1, 2, 3, 4, 5, 6, 7, 8, or 9; j is 1, 2, 3, 4, 5, or 6; R⁷, R⁸, R⁹, R¹⁰, R¹¹, and R¹² are independently hydrogen, fluorine, C₁₋₃ alkyl group, or C₁₋₃ fluoroalkyl group, and at least one of R⁷, R⁸, R⁹, R¹⁰, R¹¹ and R¹² is fluorine or C₁₋₃ fluoroalkyl group; R¹³, R¹⁴, R¹⁵, R¹⁶, R¹⁷, R¹⁸, R¹⁹, and R²⁰ are independently hydrogen, fluorine, C₁₋₃ alkyl group, or C₁₋₃ fluoroalkyl group, and at least one of R¹³, R¹⁴, R¹⁵, R¹⁶, R¹⁷, R¹⁸, R¹⁹, and R²⁰ is fluorine or C₁₋₃ fluoroalkyl group.

4. The polymer as claimed in claim 1, wherein the fluorine-containing alkene has a structure represented by Formula (IV) 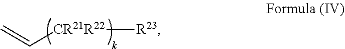
wherein k is 1, 2, 3, 4, 5, 6, 7, 8, or 9; and, R²¹, R²², and R²³ are independently hydrogen or fluorine, and at least one of R²¹, R²², and R²³ is fluorine.

5. The polymer as claimed in claim 1, wherein the fluorine-containing epoxide has a structure represented by Formula (V) 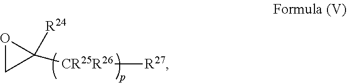
wherein p is 1, 2, 3, 4, 5, 6, 7, 8, or 9; R²⁴ is hydrogen, fluorine, or C₁₋₃ alkyl group; and, R²⁵, R²⁶, and R²⁷ are independently hydrogen or fluorine, and at least one of R²⁴, R²⁵, R²⁶, and R²⁷ is fluorine.

6. The polymer as claimed in claim 1, wherein the composition further comprises an initiator, wherein the amount of initiator is from 0.01 wt % to 10 wt based on the total weight of the first monomer and second monomer.

7. The polymer as claimed in claim 1, wherein the first monomer is 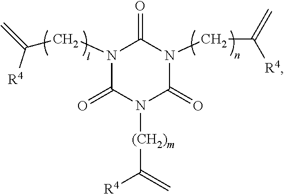
and the second monomer is fluorine-containing acrylate or fluorine-containing alkene.

8. The polymer as claimed in claim 1, wherein the first monomer is 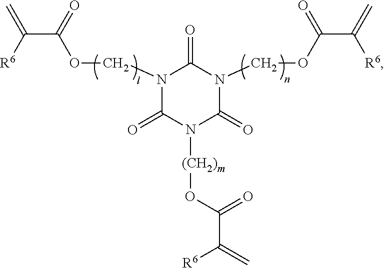
and the second monomer is fluorine-containing acrylate or fluorine-containing alkene.

9. The polymer as claimed in claim 1, wherein the first monomer is 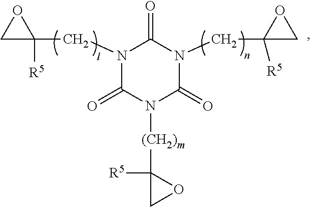
and the second monomer is fluorine-containing epoxide.

10. The polymer as claimed in claim 1, wherein the first monomer is 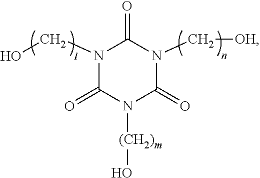
and the second monomer is fluorine-containing epoxide.

11. An electrolyte, comprising:
a lithium salt;
a solvent; and
the polymer as claimed in claim 1, wherein an amount of polymer is from 2 wt % to 20 wt %, based on the total weight of the solvent, lithium salt, and polymer.

12. The electrolyte as claimed in claim 11, wherein the weight ratio of the lithium salt to the solvent is from 1:19 to 7:13.

13. The electrolyte as claimed in claim 11, wherein the lithium salt is LiPF₆, LiClO₄, LiN(SO₂F)₂, LiBF₂(C₂O₄), LiBF₄, LiSO₃CF₃, LiN(SO₂CF₃)₂, LiN(SO₂CF₂CF₃)₂, LiAsF₆, LiSbF₆, LiAlCl₄, LiGaCl₄, LiNO₃, LiC(SO₂CF₃)₃, LiSCN, LiO₃SCF₂CF₃, LiC₆F5SO₃, LiO₂CCF₃, LiSO₃F, LiB(C₆H₅)₄, LiB(C₂O₄)₂, or a combination thereof.

14. The electrolyte as claimed in claim 11, wherein the solvent is 1,2-diethoxyethane, 1,2-dimethoxyethane, 1,2-dibutoxyethane, tetrahydrofuran (THF), 2-methyl tetrahydrofuran, dimethyl acetamide (DMAc), N-methyl-2-pyrrolidone (NMP), methyl acetate, ethyl acetate, methyl butyrate, ethyl butyrate, methyl proionate, ethyl proionate, propyl acetate (PA), γ-butyrolactone (GBL), ethylene carbonate (EC), propylene carbonate (PC), diethyl carbonate (DEC), ethylmethyl carbonate (EMC), dimethyl carbonate (DMC), vinylene carbonate, butylene carbonate, 1,3-propanesultone, dipropyl carbonate, or a combination thereof.

15. A lithium-ion battery, comprising:
a positive electrode;
a negative electrode;
a separator disposed between the positive electrode and the negative electrode; and
the electrolyte as claimed in claim 11 disposed between the positive electrode and negative electrode.

16. The lithium-ion battery as claimed in claim 15, wherein the negative electrode comprises a negative electrode active material, and the negative electrode active material is lithium metal, lithium alloy, transition metal oxide, metastable phase spherical carbon (MCMB), carbon nanotube (CNT), graphene, coke, graphite, carbon black, carbon fiber, mesophase carbon microbead, glassy carbon, lithium-containing compound, silicon-containing compound, tin, tin-containing compound, or a combination thereof.

17. The lithium-ion battery as claimed in claim 16, wherein the positive electrode comprises a positive electrode active material, and the positive electrode active material comprises elementary sulfur, organic sulfide, sulfur carbon composite, metal-containing lithium oxide, metal-containing lithium sulfide, metal-containing lithium selenide, metal-containing lithium telluride, metal-containing lithium phosphide, metal-containing lithium silicide, metal-containing lithium boride, or a combination thereof, wherein the metal is selected from a group C consisting of aluminum, vanadium, titanium, chromium, copper, molybdenum, niobium, iron, nickel, cobalt, and manganese.

18. The lithium-ion battery as claimed in claim 17, wherein the separator is polyethylene (PE), polypropylene (PP), polytetrafluoroethylene (PTFE), polyamide, polyvinylchloride (PVC), polyvinylidene difluoride, polyaniline, polyimide, polyethylene terephthalate, polystyrene (PS), cellulose, or a combination thereof.
